(19) United States
(12) Patent Application Publication
(10) Pub. No.: US 2025/0013866 A1
(43) Pub. Date: Jan. 9, 2025

(54) EFFICIENT VISION-LANGUAGE RETRIEVAL USING STRUCTURAL PRUNING

(71) Applicant: ADOBE INC., SAN JOSE, CA (US)

(72) Inventors: Handong Zhao, Cupertino, CA (US); Yue Bai, Malden, MA (US); Zhe Lin, Clyde Hill, WA (US); Ajinkya Gorakhnath Kale, San Jose, CA (US); Jiuxiang Gu, Baltimore, MD (US); Tong Yu, Fremont, CA (US); Sungchul Kim, San Jose, CA (US)

(21) Appl. No.: 18/347,877

(22) Filed: Jul. 6, 2023

(51) Int. Cl. G06N 3/082; G06N 3/04

(52) U.S. Cl. CPC G06N 3/082; G06N 3/04

(57) ABSTRACT

Systems and methods for reducing inference time of vision-language models, as well as for multimodal search, are described herein. Embodiments are configured to obtain an embedding neural network. The embedding neural network is pretrained to embed inputs from a plurality of modalities into a multimodal embedding space. Embodiments are further configured to perform a first progressive pruning stage, where the first progressive pruning stage includes a first pruning of the embedding neural network and a first fine-tuning of the embedding neural network. Embodiments then perform a second progressive pruning stage based on an output of the first progressive pruning stage, where the second progressive pruning stage includes a second pruning of the embedding neural network and a second fine-tuning of the embedding neural network.

### BACKGROUND

The following relates generally to machine learning, and more specifically to vision-language models. Recently, researchers and professionals have applied machine learning models to solve a variety of problems. For example, machine learning can be used in natural language processing, image annotation, chatbots, image editing and generation, and other domains.

Often, machine learning models create intermediate representations of data known as embeddings. The embeddings may be passed throughout the neural network and processed until a final layer or component translates the representations into human-meaningful information, such as a prediction of a value or generated image data. In some cases, the embeddings are stored for later use in tasks such as classification and search. Multimodal models, such as vision-language models, are configured to generate embeddings for multiple different types of information such as text and images in the same embedding space. This enables cross-modal tasks, such as searching for images based on text prompts. However, as such models grow in capability, they become more complex and use increased computational costs. It is possible to train a new model with fewer parameters for specific tasks, but this also uses a large amount of computational power for the training process. There is a need in the art for systems and methods to produce efficient multimodal models with decreased computational costs.

### SUMMARY

Systems and methods for increasing the efficiency of vision-language models are described. Embodiments include a multimodal search apparatus including an embedding neural network. Embodiments apply a progressive pruning process to the embedding neural network consisting of multiple rounds, during which embodiments selectively prune neurons from the model and then fine-tune the pruned model using a few training data. Some embodiments include a temporary indicator layer that is configured to identify suitable neurons for pruning. Some embodiments further include an adapter layer that is used in the progressive pruning process to realign embeddings across modalities. Accordingly, the systems and methods described herein produce a vision-language model with fewer parameters and faster inference which retains cross-modal retrieval accuracy.

A method, apparatus, non-transitory computer readable medium, and system for increasing efficiency of vision-language models are described. One or more aspects of the method, apparatus, non-transitory computer readable medium, and system include obtaining an embedding neural network, wherein the embedding neural network is pretrained to embed inputs from a plurality of modalities into a multimodal embedding space; performing a first progressive pruning stage, wherein the first progressive pruning stage includes a first pruning of the embedding neural network and a first fine-tuning of the embedding neural network; and performing a second progressive pruning stage based on an output of the first progressive pruning stage, wherein the second progressive pruning stage includes a second pruning of the embedding neural network and a second fine-tuning of the embedding neural network.

A method, apparatus, non-transitory computer readable medium, and system for increasing efficiency of vision-language models are described. One or more aspects of the method, apparatus, non-transitory computer readable medium, and system include receiving a query of a first modality, wherein the query describes an element; embedding the query into a multimodal embedding space using an embedding neural network to obtain a query embedding, wherein the embedding neural network is trained using a progressive pruning procedure; and providing a search result of a second modality different from the first modality based on the query embedding in response to the query, wherein the search result includes the element described by the query.

An apparatus, system, and method for increasing efficiency of vision-language models are described. One or more aspects of the apparatus, system, and method include at least one processor; a memory including instructions executable by the processor; and an embedding neural network comprising parameters stored in the memory and configured to embed a query into a multimodal embedding space to obtain a query embedding, wherein the embedding neural network is trained using a progressive pruning procedure.

### BRIEF DESCRIPTION OF THE DRAWINGS

FIG. 1 shows an example of a multimodal search system according to aspects of the present disclosure.

FIG. 2 shows an example of a multimodal search apparatus according to aspects of the present disclosure.

FIG. 3 shows an example of features produced by an embedding neural network before and after progressive pruning according to aspects of the present disclosure.

FIG. 4 shows an example of an embedding neural network according to aspects of the present disclosure.

FIG. 5 shows an example of a progressive pruning process according to aspects of the present disclosure.

FIG. 6 shows an example of a progressive pruning algorithm according to aspects of the present disclosure.

FIG. 7 shows an example of a method for pruning an embedding neural network according to aspects of the present disclosure.

FIG. 8 shows an example of a method for identifying candidate neurons to prune from the embedding neural network according to aspects of the present disclosure.

FIG. 9 shows an example of a method for retrieving an image based on a text prompt according to aspects of the present disclosure.

FIG. 10 shows an example of a method cross-modal search according to aspects of the present disclosure.

FIG. 11 shows an example of a computing device according to aspects of the present disclosure.

### DETAILED DESCRIPTION

There have been several recent advances in machine learning paradigms and techniques. Researchers have developed training strategies that include massive amounts of data that are applied to models during training phases in a process referred to as “large-scale pretraining.” The pretrained models achieve state of the art performance in both the generative and discriminative task domains.

Large-scale pretraining is also applied to multimodal embedding models, such as CLIP. The pretraining includes aligning millions of paired data, where the pairs include a datum of each modality such as a text and an image. CLIP in particular utilizes large-scale pretraining to train encoders that align vision and language domains in a shared space.

Large-scale pretrained models often include billions of parameters, and can use a large amount of computational power during both the pretraining and inference operations. In some cases, the amount of computational power that is used prohibits the models from being deployed in some environments, such as user devices or shared computing devices under load in a network.

Conventional methods to reduce model size include knowledge distillation techniques which train smaller networks often for a more specific domains. However, knowledge distillation involves training the new networks from scratch using relatively large datasets. This training process, though smaller than large-scale pretraining, involves a large amount of computational power as well.

Other methods include pruning a model by removing neurons within the model's neural network. Conventional methods involve finding neurons with the weakest signal, and removing them. These simple pruning methods have shown some promise in a few data processing domains. However, this type of pruning can damage the representativity of embeddings and cause a misalignment of the two modalities in the embedding space.

By contrast, the present embodiments perform a selective pruning process that identifies neurons that have the least influence on downstream tasks such as cross-modal retrieval. Embodiments then fine-tune the model after pruning, which restores alignment of the two modalities in the embedding space. Some embodiments perform this selective pruning process and fine-tuning multiple times in multiple rounds, where each round includes a pruning operation and a fine-tuning operation. In some cases, increasing the number of rounds produces a model with a decreasing number of parameters and faster inference times.

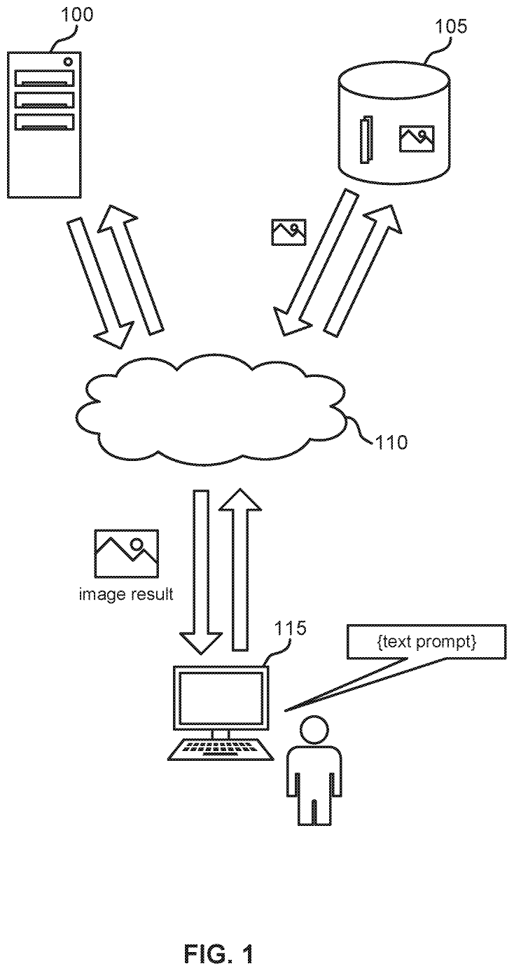

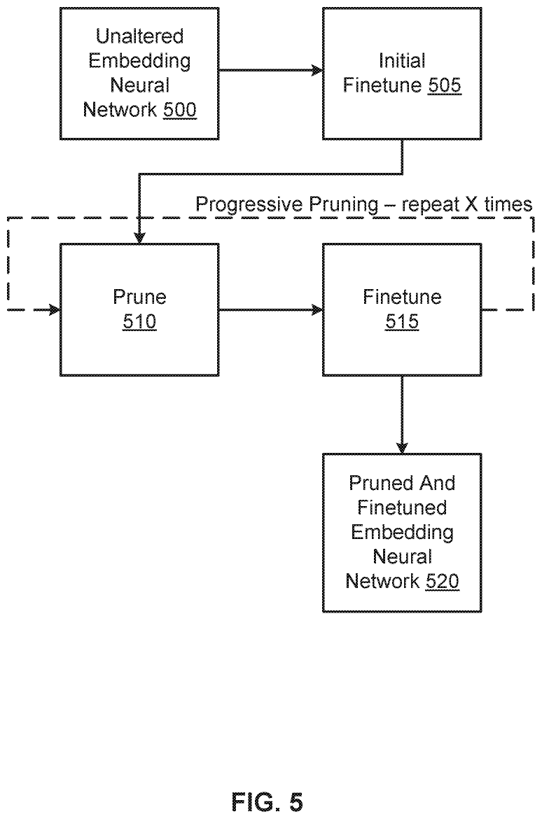

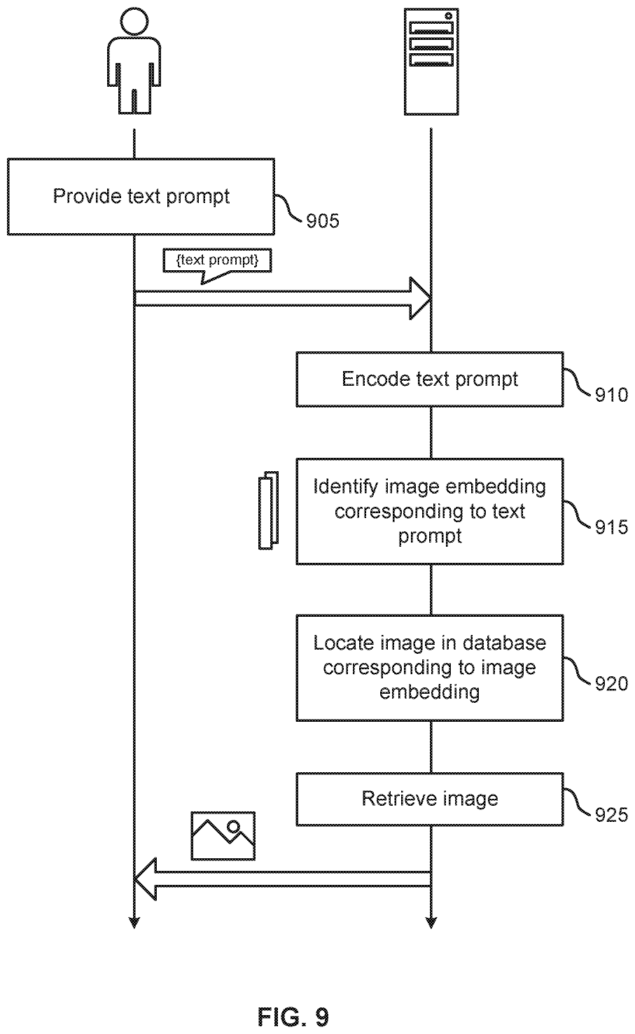

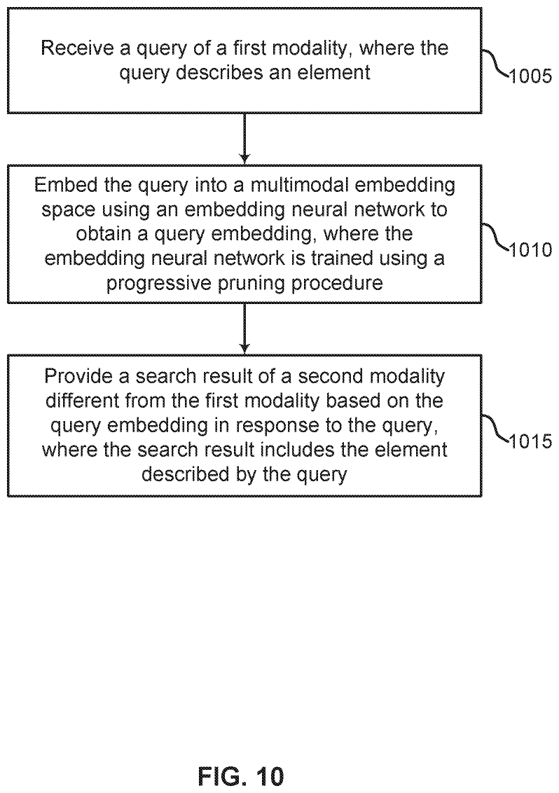

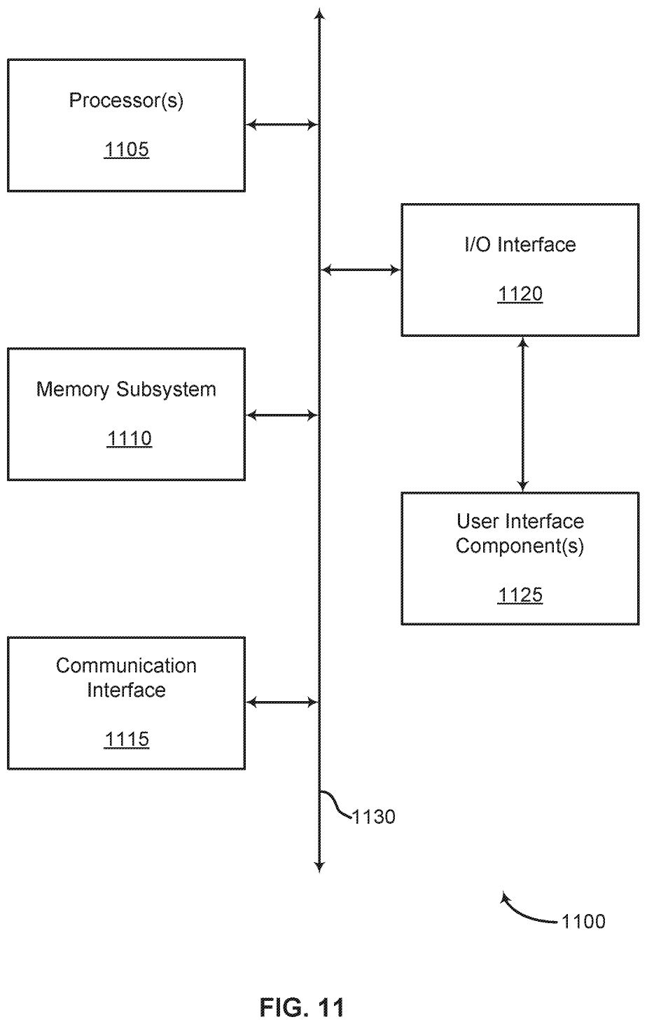

A multimodal search system is described with reference to FIGS. 1-4. A progressing pruning process is described with reference to FIGS. 5-8. Use of the model for multimodal search is described with reference to FIGS. 9-10. A computing device configured to implement a multimodal search apparatus is described with reference to FIG. 11.

### Multimodal Search System

An apparatus configured to increase efficiency of a vision-language model is described. One or more aspects of the apparatus include at least one processor; a memory including instructions executable by the processor; and an embedding neural network comprising parameters stored in the memory and configured to embed a query into a multimodal embedding space to obtain a query embedding, wherein the embedding neural network is trained using a progressive pruning procedure.

Some examples of the apparatus, system, and method further include a training component configured to perform the progressive pruning procedure by performing a first progressive pruning stage, wherein the first progressive pruning stage includes a first pruning of the embedding neural network and a first fine-tuning of the embedding neural network, and performing a second progressive pruning stage based on an output of the first progressive pruning stage, wherein the second progressive pruning stage includes a second pruning of the embedding neural network and a second fine-tuning of the embedding neural network.

Some examples of the apparatus, system, and method further include a user interface configured to receive the query and display a search result obtained in response to the query. Some examples of the apparatus, system, and method further include a search engine configured to compare the query embedding to a candidate embedding. In some aspects, the embedding neural network comprises a transformer architecture.

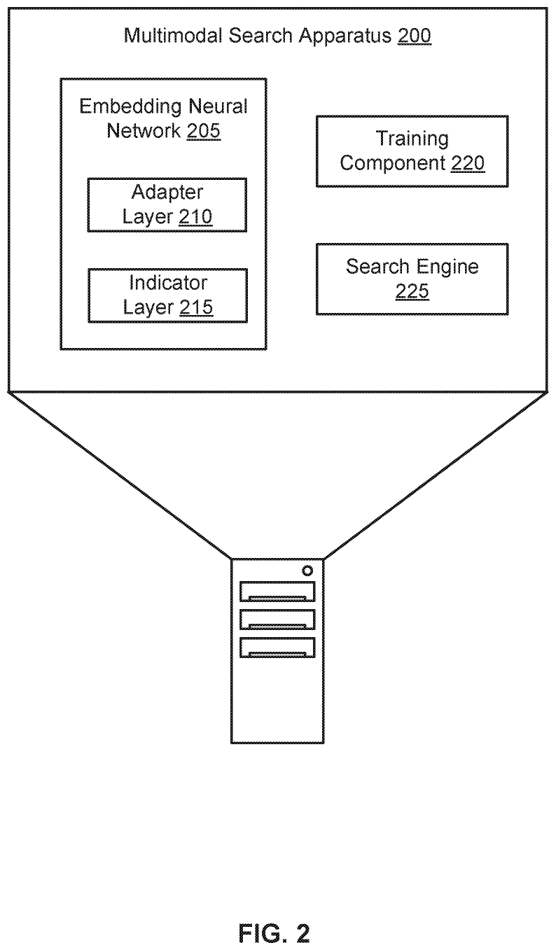

FIG. 1 shows an example of a multimodal search system according to aspects of the present disclosure. The example shown includes multimodal search apparatus 100, database 105, network 110, and user interface 115. Multimodal search apparatus 100 is an example of, or includes aspects of, the corresponding element described with reference to FIG. 2.

In an example operation, a user inputs a text prompt to user interface 105. The prompt is sent to multimodal search apparatus 100 over network 110. Multimodal search apparatus 100 encodes the prompt to create an embedding. An embedding is a data structure such as a vector comprising a series of numbers, which encodes information about the prompt that multimodal search apparatus 100 is able to understand for certain tasks. Multimodal search apparatus 100 then compares the embedding with other embeddings stored in database 105. In some examples, multimodal search apparatus 100 searches for embeddings within an image cluster of embeddings. Then, multimodal search apparatus 100 identifies an image based on the comparison. The comparison between embeddings indicates that the image has a strong correspondence to the input text prompt. The system then provides the image result to the user through user interface 115.

Multimodal search apparatus 100 is configured to generate embeddings of both vision based prompts such as images and language based prompts such as texts. Embodiments of multimodal search apparatus 100 are implemented on a server connected to network 110. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Database 105 is configured to store data used by multimodal search apparatus 100. In some examples, database 105 stores a directory of embeddings corresponding to images and texts, as well as the actual images and texts. In some cases, database 105 further stores pretrained vision language models, which multimodal search apparatus 100 can use in a progressive pruning process. A database is an organized collection of data. For example, a database stores data in a specified format known as a schema. A database may be structured as a single database, a distributed database, multiple distributed databases, or an emergency backup database. In some cases, a database controller may manage data storage and processing in database 105. In some cases, a user interacts with the database controller. In other cases, the database controller may operate automatically without user interaction.

Network 110 is used to facilitate the transfer of information between multimodal search apparatus 100, database 105, and user interface 115. Sometimes, network 110 is referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

User interface 115 is configured to receive input from a user and communicate with other systems such as multimodal search apparatus 100. In some examples, user interface 100 includes a graphical user interface (GUI), which may be implemented within a web-based application or standalone software. Additional detail regarding user interface component(s) will be described with reference to FIG. 11.

According to some aspects, user interface 115 receives a query of a first modality, where the query describes an element. In some aspects, the first modality of the query is a text modality and where the second modality of the search result is an image modality. According to some aspects, user interface 115 is configured to display a search result that includes the element in response to the query.

FIG. 2 shows an example of a multimodal search apparatus 200 according to aspects of the present disclosure. The example shown includes multimodal search apparatus 200, embedding neural network 205, training component 220, and search engine 225. Multimodal search apparatus 200 is an example of, or includes aspects of, the corresponding element described with reference to FIG. 1.

Embodiments of multimodal search apparatus 200 include several components. The term ‘component’ is used to partition the functionality enabled by the processor(s) and the executable instructions included in the computing device used to multimodal search apparatus 200 (such as the computing device described with reference to FIG. 11). The partitions may be implemented physically, such as through the use of separate circuits or processors for each component, or may be implemented logically via the architecture of the code executable by the processors.

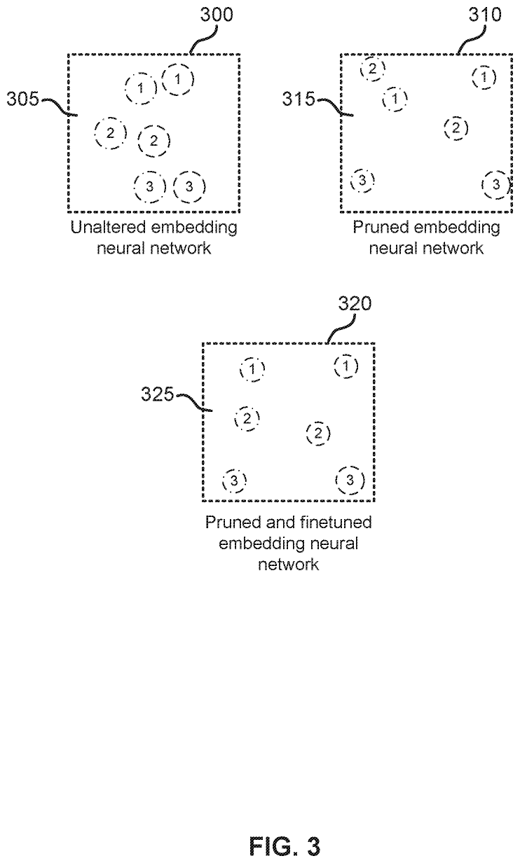

Embedding neural network 200 is configured to embed either vision or language-based prompts into a common embedding space. Embodiments of embedding neural network 205 include one or more neural networks. A neural network is a type of computer algorithm that is capable of learning specific patterns without being explicitly programmed, but through iterations over known data. A neural network may refer to a cognitive model that includes input nodes, hidden nodes, and output nodes. Nodes in the network may have an activation function that computes whether the node is activated based on the output of previous nodes. Training the system may involve supplying values for the inputs, and modifying edge weights and activation functions (algorithmically or randomly) until the result closely approximates a set of desired outputs. Additional detail regarding the neural network sub-structures used in embedding neural network 200 will be provided with reference to FIG. 3.

According to some aspects, embedding neural network 205 embeds a query received from a user into a multimodal embedding space to obtain a query embedding. According to some aspects, embedding neural network 205 is trained using a using a progressive pruning procedure. Details regarding the progressive pruning procedure will be provided with reference to FIGS. 5-8.

In one aspect, embedding neural network 205 includes adapter layer 210 and indicator layer 215. Though adapter layer 210 and indicator layer 215 include a singular “layer” in their name, embodiments of both adapter layer 210 and indicator layer 215 may each include multiple layers with trainable parameters.

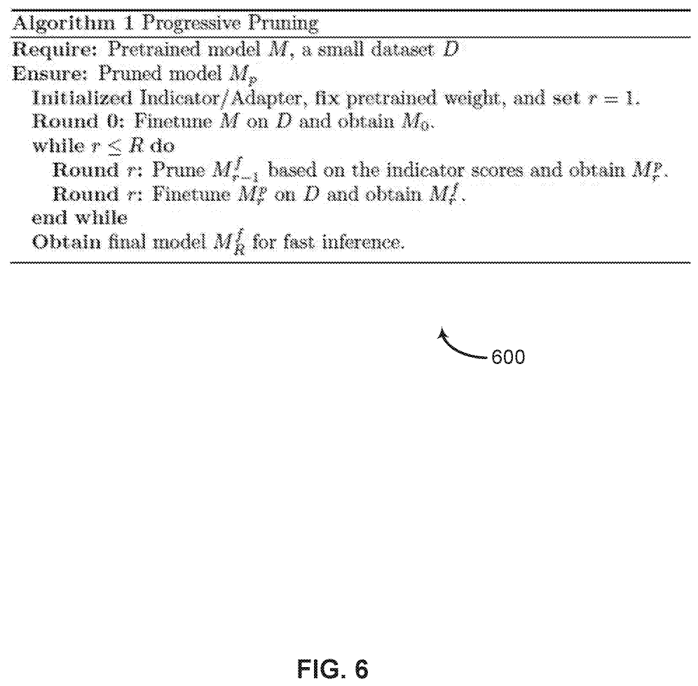

Adapter layer 210 is a type of trainable network that is configured to be appended to an existing model. Some examples of adapter layer 210 include a bottleneck structure with multiple layers and skip connections. Additional detail regarding an adapter layer 210 will be provided with reference to FIGS. 5-6.

Indicator layer 215 is used by embedding neural network 205 to identify candidate neurons for pruning. Some examples of indicator layer 215 include neurons that indicate importance scores of corresponding neurons elsewhere in the model. According to some aspects, embedding neural network 205 selectively prunes neurons during a progressive pruning process based on the importance scores.

According to some aspects, embedding neural network 205 removes the temporary indicator layer 215 from the embedding neural network 205 following the second progressive pruning stage. In some examples, embedding neural network 205 adds an adapter layer 210 to the embedding neural network 205 prior to the first progressive pruning stage.

Training component 220 is configured to execute the progressive pruning process. In some embodiments, training component 220 obtains importance scores provided by indicator layer 215 to identify neurons to remove from embedding neural network 205. In some embodiments, training component 220 computes a loss associated with a task such as cross-modal search to determine which neurons to remove from embedding neural network 205. Embodiments of training component 220 are further configured to compute a loss based on the task, and then to adjust parameters embedding neural network 205 based on the loss. In some cases, the parameters are parameters that belong to adapter layer 210. In some examples, training component 220 uses training data when computing the loss. The training data may be a relatively small subset of the training data used in a pretraining phase of embedding neural network 205, e.g. less than 1%.

In some cases, a user or developer determines a number of rounds to include in a progressive pruning process. By contrast, in some cases, training component 220 determines the number of rounds to include during the progressive pruning process. In some embodiments, training component 220 computes a number of rounds to include by minimizing a function including the size of the network and an inference time, and maximizing a function indicating the accuracy of the network.

In some examples, training component 220 performs a first progressive pruning stage, where the first progressive pruning stage includes a first pruning of the embedding neural network 205 and a first fine-tuning of the embedding neural network 205. In some examples, training component 220 performs a second progressive pruning stage based on an output of the first progressive pruning stage, where the second progressive pruning stage includes a second pruning of the embedding neural network 205 and a second fine-tuning of the embedding neural network 205.

In some examples, training component 220 iteratively performs a predetermined number of progressive pruning procedures on the embedding neural network 205. In some examples, training component 220 computes a contrastive learning loss, where the first fine-tuning is based on the contrastive learning loss. In some examples, training component 220 trains the embedding neural network 205 together with the temporary indicator layer 215 prior to the first progressive pruning stage, where the first pruning is based on the temporary indicator layer 215. In some examples, training component 220 determines a pruning threshold for the first pruning. In some examples, training component 220 identifies an element of the temporary indicator layer 215 that is less than the pruning threshold. In some examples, training component 220 prunes a neuron of the embedding neural network 205 corresponding to the element of the temporary indicator layer 215. An example of a pruning threshold is around 10% of the neurons in the network, per round.

In some examples, training component 220 pretrains the embedding neural network 205 prior to the first progressive pruning stage. In some aspects, the first fine-tuning includes a few-shot fine-tuning based on less than 1% of an amount of training data used for the pretraining. In some aspects, the progressive pruning procedure includes a set of pruning phases alternating with a set of fine-tuning phases.

Search engine 225 is configured to compare embeddings in the multimodal embedding space, and return one or more embeddings that are similar to a query embedding. According to some aspects, search engine 225 provides a search result of a second modality different from the first modality based on the query embedding in response to the query, where the search result includes the element described by the query. In some examples, search engine 225 compares the query embedding to a candidate embedding corresponding to the search result, where the search result is retrieved based on the comparison.

FIG. 3 shows an example of features produced by an embedding neural network before and after progressive pruning according to aspects of the present disclosure. The example shown includes unaltered embedding neural network 300, pruned embedding neural network 310, and pruned and finetuned embedding neural network 320. Unaltered embedding neural network 300 is an example of, or includes aspects of, the corresponding element described with reference to FIG. 5. Pruned and finetuned embedding neural network 320 is an example of, or includes aspects of, the corresponding element described with reference to FIG. 5.

In one aspect, unaltered embedding neural network 300 includes aligned features 305. Unaltered neural network 300 refers to an embedding neural network that has been pretrained without having a progressive pruning cycle applied to it. Aligned features 305 include both language embeddings, which are represented by the circles including a dash-dot pattern, and vision embeddings, which are represented by the circles including a dash-dash pattern. For example, the dash-dot ‘1’ may be a text embedding of the words “a brown dog”, and the dash-dash ‘1’ may be an image embedding of an image of a brown dog.

In some examples, unaltered embedding neural network 300 produces features that are both close and aligned. The terms “close together” and “aligned” can sometimes be used interchangeably, but they can also have slightly different meanings in the context of embedding spaces. When features (e.g., embeddings or portions of embeddings) are “close together” in an embedding space, this means that their vector representations are located near each other in the space. This proximity can be measured using a distance metric, such as Euclidean distance or cosine similarity. For example, if two words have similar meanings, their embeddings might be located near each other in the embedding space, which would make them “close together”.

On the other hand, when features are “aligned” in an embedding space, this means that they have a consistent relationship or association with each other. This relationship can be more complex than just proximity in the embedding space and might be based on more abstract features or concepts. For example, in a language model, two words might be “aligned” if they tend to occur in similar contexts or have similar syntactic structures, even if their vector representations are not very close to each other in the embedding space.

In summary, “close together” refers to the physical proximity of features in the embedding space, while “aligned” refers to the semantic or contextual relationship between features, which may or may not correspond to physical proximity in the embedding space. In some cases, either algorithms or learned networks are used to extract features that are aligned with each other.

When pruned without fine-tuning, unaltered embedding neural network 300 becomes pruned network 310. In some cases, pruned network 310 includes (e.g., produces) drifted features 315. The drifted features 315 may be both further away from and unaligned from each other as compared to aligned features 305. This may be due to the effect of the pruning, which removes connections in the machine learning model thereby affecting the final embeddings. In some cases, the embeddings produced by this version of the model do not provide sufficient accuracy in downstream tasks such as cross-modal search and retrieval.

When pruned network 310 is pruned and fine-tuned, it becomes pruned and finetuned embedding neural network 320. In some embodiments, pruned and finetuned embedding neural network 320 includes an adapter layer that learns to re-align the multimodal embeddings during the fine-tuning process. In one aspect, pruned and finetuned embedding neural network 320 includes (e.g., produces) re-aligned features 325.

As represented by FIG. 3, re-aligned features 325 have not necessarily been restored to the same position in the multimodal embedding space aligned features 305. For example, the embeddings of both the text and the image including the brown dog as mentioned above may still be further apart than they were in aligned features 305. However, as represented by their relative positions in the image of pruned and finetuned embedding neural network 320, corresponding text and image features may be re-aligned such that they can be matched at inference time, e.g., during cross-modal search and retrieval. For example, cross-modal retrieval may involve embedding a query of a first modality into the embedding space, and then finding a corresponding embedding of a second modality in the embedding space. Embeddings originating from data of the second modality may be in, for example, their own cluster or grouping in the embedding space. A search engine may look in the cluster of the second modality to find a corresponding second modality embedding, and then return the second modality data associated with that embedding.

Once the multimodal embedding network has been fine-tuned, it can again produce embeddings of a first modality that are aligned with embeddings of a second modality. Accordingly, the embeddings of different modalities can correspond to each other at inference time. In this way, the functionality of pruned and finetuned embedding neural network 320 is restored, and may be used for accurate cross-modal search and retrieval.

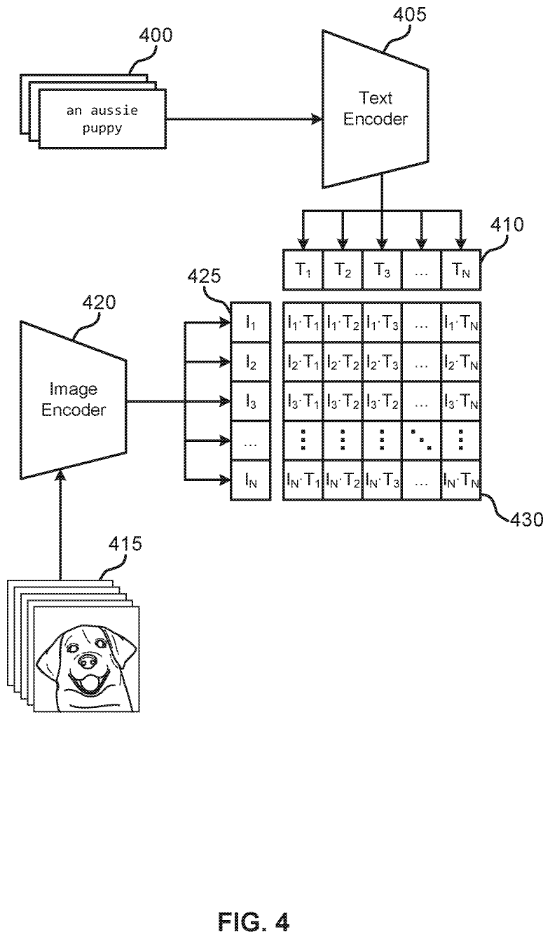

FIG. 4 shows an example of an embedding neural network according to aspects of the present disclosure. The example shown includes texts 400, text encoder 405, text encodings 410, images 415, image encoder 420, image encodings 425, and image-text pairs 430.

In at least one embodiment, the embedding neural network shown by FIG. 4 is based on a CLIP model. CLIP, or Contrastive Language-Image Pre-training, describes both an architecture and a training method for a model. The CLIP architecture consists of two main components: a visual encoder, e.g., image encoder 400, and a language encoder, e.g., text encoder 405. The visual encoder is a convolutional neural network (CNN) that processes the input image and produces a fixed-length vector representation, or embedding, that captures its visual features. The language encoder is a transformer-based language model, such as GPT, that processes the input text and produces a fixed-length vector representation, or embedding, that captures its linguistic features.

During training, CLIP is trained to associate each image of images 415 with a set of related natural language descriptions, e.g., texts 400. Further, CLIP learns to associate each text of texts 400 with a set of images 415. CLIP effectively learns how similar each image of images 415 is to a given text, and vice versa. This is done using a contrastive learning objective, which encourages the model to learn embeddings that bring together matching image-caption pairs while separating them from non-matching pairs. Specifically, CLIP is trained to maximize the similarity between an image embedding and the embeddings of its associated text, while minimizing the similarity between the image embedding and the embeddings of non-associated text. In some cases, this training process is referred to as “large-scale pretraining”, and includes adjusting parameters of both the visual encoder and the language encoder.

In some examples, both text encoder 405 and image encoder 420 produced fixed-length embeddings. In some examples, the fixed-length embeddings have a predetermined dimensionality, which determines the dimensionality of an embedding space. In some examples, the embedding space is a multimodal embedding space. Multimodal embedding space refers to a shared space where data of multiple modalities, such as text and images, are represented as numerical vectors or points. For example, these vectors are generated using an embedding neural network, which transforms the input data into a numerical representation that captures important features or characteristics of the data. According to some embodiments, an embedding network including text encoder 405 and image encoder 420 model encodes both language-based and vision-based data into the fixed-length embeddings in the embedding space, therefore the embedding space is a multimodal embedding space. During the large-scale pretraining, the model computes similarity scores between embeddings, and then computes a contrastive loss based on the similarity scores and the known correspondence (e.g., known text-image pairs) from the training data. Then, the parameters of the model are updated using a stochastic gradient descent to minimize the contrastive loss. For example, referring image-text pairs 430, the model learns to generate similar embeddings for image “I₁” and for text “T₁”.

Text encoder 405 is configured to generate text encodings 410 in the multimodal embedding space. Embodiments of text encoder 405 include a ResNet. A ResNet is a neural network architecture that addresses issues associated with training deep neural networks. It operates by including identity shortcut connections that skip one or more layers of the network. In a ResNet, stacking additional layers doesn't degrade performance or introduce training errors because skipping layers avoids the vanishing gradient problem of deep networks. In other words, the training gradient can follow “shortcuts” through the deep network. Weights are adjusted to “skip” a layer and amplify a previous skipped layer. In an example scenario, weights for an adjacent layer are adjusted and weights are not applied to an upstream layer.

Image encoder 420 is configured to generate image encodings 425 in the multimodal embedding space. Embodiments of image encoder 420 include a vision transformer. A vision transformer (e.g., the ViT model) is a neural network model configured for computer vision tasks. Unlike traditional convolutional neural networks (CNNs), ViT uses a transformer architecture, which was originally developed for natural language processing (NLP) tasks. ViT breaks down an input image into a sequence of patches, which are then fed through a series of transformer encoder layers. The output of the final encoder layer is fed into a multi-layer perceptron (MLP) head for classification. ViT can capture long-range dependencies between patches without relying on spatial relationships. In at least one embodiment, the progressive pruning process (which will be described with reference to FIG. 5) includes fine-tuning an adapter layer that is appended to image encoder 420.

### Progressive Pruning

A method for increasing efficiency of vision-language models is described. One or more aspects of the method include obtaining an embedding neural network, wherein the embedding neural network is pretrained to embed inputs from a plurality of modalities into a multimodal embedding space; performing a first progressive pruning stage, wherein the first progressive pruning stage includes a first pruning of the embedding neural network and a first fine-tuning of the embedding neural network; and performing a second progressive pruning stage based on an output of the first progressive pruning stage, wherein the second progressive pruning stage includes a second pruning of the embedding neural network and a second fine-tuning of the embedding neural network.

Some examples of the method, apparatus, non-transitory computer readable medium, and system further include determining a number of progressive pruning procedures. Some examples further include iteratively performing the number of progressive pruning procedures on the embedding neural network. Some examples of the method, apparatus, non-transitory computer readable medium, and system further include pretraining the embedding neural network prior to the first progressive pruning stage.

Some examples of the method, apparatus, non-transitory computer readable medium, and system further include computing a contrastive learning loss, wherein the first fine-tuning is based on the contrastive learning loss. In some examples, the fine-tuning is performed on a subset of layers of the embedding neural network, while parameters of other layers are held fixed. In some aspects, the first fine-tuning stage involves few-shot fine-tuning, which uses only a small fraction (e.g., less than 1%) of the training data used for the pretraining. This approach enables the model to adapt to new tasks quickly, without requiring a large amount of training data. By using a smaller amount of data, the fine-tuning process can be completed more quickly and with fewer computational resources.

Some examples of the method, apparatus, non-transitory computer readable medium, and system further include adding a temporary indicator layer to the embedding neural network. Some examples further include training the embedding neural network together with the temporary indicator layer prior to the first progressive pruning stage, wherein the first pruning is based on the temporary indicator layer. Some examples further include removing the temporary indicator layer from the embedding neural network following the second progressive pruning stage.

Some examples of the method, apparatus, non-transitory computer readable medium, and system further include determining a pruning threshold for the first pruning. Some examples further include identifying an element of the temporary indicator layer that is less than the pruning threshold. Some examples further include pruning a neuron of the embedding neural network corresponding to the element of the temporary indicator layer. In some embodiments, the pruning threshold is about 10% of the neurons of the embedding neural network. Embodiments are not limited thereto, however, and the threshold may be greater or less than 10%.

Some examples of the method, apparatus, non-transitory computer readable medium, and system further include identifying a subset of layers of the embedding neural network for fine-tuning, wherein the first pruning is performed on the subset of layers of the embedding neural network. In some aspects, the subset of layers includes a feed-forward layer.

Some examples of the method, apparatus, non-transitory computer readable medium, and system further include adding an adapter layer to the embedding neural network prior to the first progressive pruning stage. In some examples, the subset of layers correspond to the adapter layer.

FIG. 5 shows an example of a progressive pruning process according to aspects of the present disclosure. The example shown includes unaltered embedding neural network 500, initial fine-tune 505, prune 510, fine-tune 515, and pruned and finetuned embedding neural network 520. Unaltered embedding neural network 500 is an example of, or includes aspects of, the corresponding element described with reference to FIG. 3. Pruned and finetuned embedding neural network 520 is an example of, or includes aspects of, the corresponding element described with reference to FIG. 3. The steps illustrated in FIG. 5 may be performed by a training component as described with reference to FIG. 2.

Progressive pruning may refer to reducing the size and complexity of a neural network by iteratively pruning and fine-tuning its parameters. In the example shown in FIG. 5, of a multimodal search apparatus first obtains unaltered embedding neural network 500. In some embodiments, unaltered embedding neural network 500 is a vision-language multimodal model. In at least one embodiment unaltered embedding neural network 500 is or is based on a pretrained CLIP model.

Some embodiments of the progressive pruning process include an initial fine-tune 505, which may be referred to as “round 0”. In some cases, the process appends an indicator layer and an adapter network to unaltered embedding neural network 500 before the initial fine-tune 505. Then, the initial fine-tune 505 uses a few data from a dataset to update the indicator and adapter. In some embodiments, initial fine-tune 505 adjusts parameters of the embedding neural network. The parameters may be parameters of the adapter. The initial fine-tune 505 may additionally identify neurons to prune in the proceeding step.

The progressing pruning cycle includes the pruning step prune 510 and the fine-tuning step fine-tune 515. In some examples, prune 510 selectively deletes a threshold number of neurons from the embedding neural network. In some embodiments, the indicator layer identifies neurons that are predicted to have the least effect on the representativity of embeddings. For example, the indicator layer may include a layer with a number of neurons equal to a number of pruneable neurons in the embedding neural network. The values of the neurons in this layer may represent importance scores of the corresponding pruneable neurons. A training component may then prune the neurons by disconnecting them or zeroing out their weights based on the importance scores. In some examples, the training component prunes a predetermined percentage of neurons, such as 10%. In at least one example, the multimodal search apparatus includes indicator layer after the layer of the embedding neural network that produces the embedding in the multimodal embedding space. In some examples, this layer belongs to an image encoder of the embedding neural network.

In some cases, prune 510 damages the output of the embedding neural network. The “damage” can refer to changes to the embedding neural network that affect its ability to produce useful embeddings. Accordingly, embodiments of the progressive pruning process additionally include fine-tune 515. Fine-tune 515 uses a relatively small amount of data to adjust parameters of the embedding neural network to realign the embeddings of different modalities. In some embodiments, fine-tune 515 adjusts parameters of the adapter, while holding other parameters of the network fixed. The fine-tune 515 restores the embedding neural network's capability to generate embeddings that allow for accurate downstream tasks such as cross-modal retrieval.

If the training component has determined that more than one round will be effective, the progressive pruning cycle proceeds by returning to prune 510, and then again to fine-tune 515 to complete an additional round. According to some embodiments, the progressive pruning cycles are repeated X times (or X rounds) to produce pruned and fine-tuned embedding neural network 520, wherein X is a natural number greater than 1. Accordingly, embodiments perform the progressive pruning cycle for multiple rounds to produce pruned and finetuned embedding neural network 520. Each round decreases the size of the network by a threshold amount (e.g., a ratio of the current number of neurons, or a flat value), thereby decreasing the memory and computational requirements of the network. Each round further includes a fine-tuning step using a small number of data to restore the representativity of the network. In this way, embodiments of the present disclosure produce a vision-language model with increased efficiency.

FIG. 6 shows an example of a progressive pruning algorithm 600 according to aspects of the present disclosure. FIG. 6 provides additional detail for an example of the progressive pruning process.

In this example of the algorithm, a multimodal search apparatus first obtains a pretrained model M, and a small dataset D. The dataset D may be a subset of a larger dataset used in the pretraining of the model. In some cases, the size of D is less than 1% of the size of the dataset used during pretraining.

The algorithm proceeds to the “ensure” block, which can be handled by a training component such as the one described with reference to FIG. 2. The “ensure” block may execute according to predetermined constraints, such as a maximum size of the final network or a minimum level of accuracy for a downstream task. The algorithm then proceeds by initializing an indicator layer and an adapter network, and appending them to the pretrained model M. The indicator layer and the adapter network may be initialized by setting their parameters to a constant value.

In one example, the pruning is performed on a feedforward layer of the embedding neural network. The feedforward layer FFN may be represented by:

$$FFN = max ( 0 , {xW}_{1} + {b}_{1} ) {W}_{2} + {b}_{2} \qquad ( 1 )$$

where max (0, xW₁+b₁) represents the hidden representation of a feature. Once an indicator layer is appended to this, the representation becomes:

$$FFN = ( max ( 0 , {xW}_{1} + {b}_{1} ) ⊙ Ind ) {W}_{2} + {b}_{2} \qquad ( 2 )$$

where Ind ∈ [symbol] ^{d} is the indicator layer, and d is the dimension of the hidden layer. ⊙ refers to an element-wise production, such that the values of the neurons in the indicator layer have a 1:1 correspondence to the neurons of the hidden layer. The indicator layer is initialized by setting its weights to a constant value, such as 1, and is updated by backpropagation to indicate the importance of corresponding neurons from the hidden layer.

Embodiments further include an adapter layer. In some examples, the adapter layer includes a bottleneck structure with residual skip connections. The algorithm proceeds to “Round 0” which finetunes the model M on the small dataset D to obtain the round 0 version of the embedding neural network, M₀.

In some cases, the training component determines a number of progressive tuning rounds R. The algorithm then proceeds with a pruning operation and a fine-tuning operation in each round for the number of determined rounds. Additional detail regarding the pruning and the fine-tuning is provided with reference to FIG. 5. In some embodiments, the number of rounds R is configured by a user.

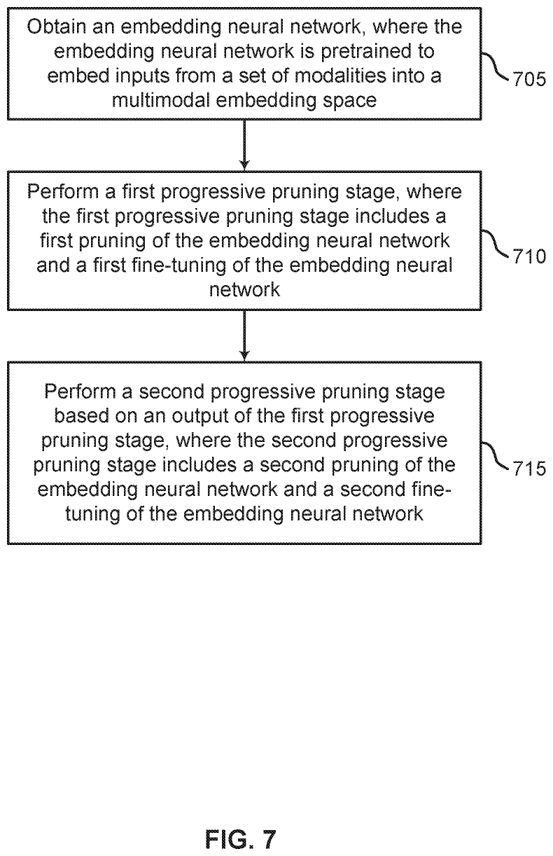

FIG. 7 shows an example of a method 700 for pruning an embedding neural network according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system obtains an embedding neural network, where the embedding neural network is pretrained to embed inputs from a set of modalities into a multimodal embedding space. In some cases, the embedding neural network is based on a CLIP architecture, such as the one described with reference to FIG. 4.

At operation 710, the system performs a first progressive pruning stage, where the first progressive pruning stage includes a first pruning of the embedding neural network and a first fine-tuning of the embedding neural network. In some cases, the operations of this step refer to, or may be performed by, a training component as described with reference to FIG. 2. In some cases, the first pruning and the first fine-tuning of the embedding neural network corresponds to the “Round 0” pruning and fine-tuning described with reference to FIGS. 5-6.

At operation 715, the system performs a second progressive pruning stage based on an output of the first progressive pruning stage, where the second progressive pruning stage includes a second pruning of the embedding neural network and a second fine-tuning of the embedding neural network. In some cases, the operations of this step refer to, or may be performed by, a training component as described with reference to FIG. 2. The system may perform the progressive pruning according to the process and algorithm described with reference to FIGS. 5-6. In some embodiments, the second pruning and the second fine-tuning correspond to a first round after the initial round 0 as described with reference to FIG. 5.

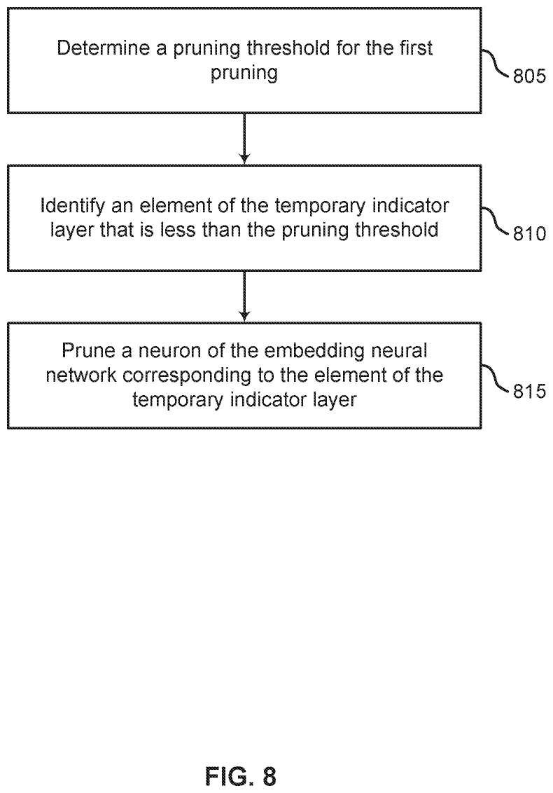

FIG. 8 shows an example of a method 800 for identifying candidate neurons to prune from the embedding neural network according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system determines a pruning threshold for the first pruning. In some cases, the operations of this step refer to, or may be performed by, a training component as described with reference to FIG. 2. In some examples, the pruning threshold is 10% or some other ratio of the current neurons in the embedding neural network. In at least one example, the pruning threshold is 10% of neurons in a layer corresponding to a the hidden representation, e.g., the embedding of the input data that is stored in the multimodal embedding space. In some examples, the pruning threshold is a flat number of neurons.

At operation 810, the system identifies an element of the temporary indicator layer that is less than the pruning threshold. In some cases, the operations of this step refer to, or may be performed by, a training component as described with reference to FIG. 2. For example, as described with reference to FIGS. 5-6, an indicator layer may include neurons whose values represent an “importance score” for the neurons of a hidden representation layer. The system may adjust the parameters of the indicator layer during fine-tuning and learn to predict the importance scores. The importance scores represent to each neuron's significance in a final generated embedding; they do not necessarily correlate to the magnitude or signal strength of the neurons. In some cases, neurons that output weaker signals are more significant in the generation of the final embedding in the multimodal embedding space.

At operation 815, the system prunes a neuron of the embedding neural network corresponding to the element of the temporary indicator layer. In some cases, the operations of this step refer to, or may be performed by, a training component as described with reference to FIG. 2. In some cases, the system zeroes out the weights for a neuron or disables inbound and outbound connections from the neuron to prune it.

### Multimodal Search

A method for increasing efficiency of vision-language models is described. One or more aspects of the method include receiving a query of a first modality, wherein the query describes an element; embedding the query into a multimodal embedding space using an embedding neural network to obtain a query embedding, wherein the embedding neural network is trained using a progressive pruning procedure; and providing a search result of a second modality different from the first modality based on the query embedding in response to the query, wherein the search result includes the element described by the query. In some aspects, the progressive pruning procedure comprises a plurality of pruning phases alternating with a plurality of fine-tuning phases.

Some examples of the method, apparatus, non-transitory computer readable medium, and system further include comparing the query embedding to a candidate embedding corresponding to the search result, wherein the search result is retrieved based on the comparison. In some aspects, the first modality of the query is a text modality and wherein the second modality of the search result is an image modality.

FIG. 9 shows an example of a method 900 for retrieving an image based on a text prompt according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, a user provides a text prompt. The user may do so through a user interface such as the one described with reference to FIG. 1. The user interface may include a graphical user interface as part of a web-app or software.

At operation 910, the system encodes the text prompt. For example, the system may encode the text prompt using an embedding neural network such as the one described with reference to FIG. 2. The embedding neural network may be pruned and finetuned according to the process described with reference to FIGS. 5-6. Accordingly, the embedding neural network may encode the text prompt with reduced inference time as compared to an unaltered vision-language model.

At operation 915, the system identifies an image embedding corresponding to the text prompt. The system may identify the embedding by finding an image embedding that has the closest alignment to the text embedding from the text prompt. Additional information regarding processes for corresponding image embeddings to text embeddings is provided with reference to FIG. 3.

At operation 920, the system locates the image in a database, where the image corresponds to the image embedding. For example, a database may store image embeddings and their corresponding image data separately. In some embodiments, the system may decode the image embedding to generate image data and provide it to the user instead.

At operation 925, the system retrieves the image and displays it to the user. The system may display the image using the user interface described above.

FIG. 10 shows an example of a method 1000 for cross-modal search according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system receives a query of a first modality, where the query describes an element. For example, a user may input a query using a user interface as described with reference to FIG. 1. In some cases, the modality is a text modality.

At operation 1010, the system embeds the query into a multimodal embedding space using an embedding neural network to obtain a query embedding, where the embedding neural network is trained using a progressive pruning procedure. In some cases, the operations of this step refer to, or may be performed by, the embedding neural network as described with reference to FIG. 2. The embedding neural network may embed the query embedding into a multimodal embedding space which can represent data originating from different modalities. Additional detail regarding the embedding neural network and the multimodal embedding space is provided with reference to FIG. 3.

At operation 1015, the system provides a search result of a second modality different from the first modality based on the query embedding in response to the query, where the search result includes the element described by the query. In some cases, the operations of this step refer to, or may be performed by, a search engine as described with reference to FIG. 2. The search engine may compare embeddings by, for example, computing a cosine similarity between embeddings. Then, the search engine may identify an embedding originating from data of the second modality that corresponds to the query of the first embedding, and obtain the search result from the identified embedding. For example, the embedding may be associated with an identifier that a database can use to obtain the original data. In an example use case, a user may provide a text query for “a brown dog”, and the system may retrieve a picture of a brown dog using this embedding search process. In at least one embodiment, the search engine uses other means to identify the search result. For the search engine may use another trained network to find corresponding embeddings in the embedding space, or computational metrics that identify two embeddings of different modalities with the closest alignment.

FIG. 11 shows an example of a computing device 1100 according to aspects of the present disclosure. The example shown includes computing device 1100, processor(s), memory subsystem 1110, communication interface 1115, I/O interface 1120, user interface component(s), and channel 1130.

In some embodiments, computing device 1100 is an example of, or includes aspects of, multimodal search apparatus 100 of FIG. 1. In some embodiments, computing device 1100 includes one or more processors 1105 that can execute instructions stored in memory subsystem 1110 to obtain an embedding neural network, wherein the embedding neural network is pretrained to embed inputs from a plurality of modalities into a multimodal embedding space; perform a first progressive pruning stage, wherein the first progressive pruning stage includes a first pruning of the embedding neural network and a first fine-tuning of the embedding neural network; and perform a second progressive pruning stage based on an output of the first progressive pruning stage, wherein the second progressive pruning stage includes a second pruning of the embedding neural network and a second fine-tuning of the embedding neural network.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to some aspects, user interface component(s) 1125 enable a user to interact with computing device 1100. In some cases, user interface component(s) 1125 include an audio device, such as an external speaker system, an external display device such as a display screen, an input device (e.g., a remote control device interfaced with a user interface directly or through the I/O controller), or a combination thereof. In some cases, user interface component(s) 1125 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an embedding neural network, wherein the embedding neural network is pretrained to embed inputs from a plurality of modalities into a multimodal embedding space;
performing a first progressive pruning stage, wherein the first progressive pruning stage includes a first pruning of the embedding neural network and a first fine-tuning of the embedding neural network; and
performing a second progressive pruning stage based on an output of the first progressive pruning stage, wherein the second progressive pruning stage includes a second pruning of the embedding neural network and a second fine-tuning of the embedding neural network.

2. The method of claim 1, further comprising:
determining a number of progressive pruning procedures; and
iteratively performing the number of progressive pruning procedures on the embedding neural network.

3. The method of claim 1, further comprising:
computing a contrastive learning loss, wherein the first fine-tuning is based on the contrastive learning loss.

4. The method of claim 1, further comprising:
adding a temporary indicator layer to the embedding neural network; and
training the embedding neural network together with the temporary indicator layer prior to the first progressive pruning stage, wherein the first pruning is based on the temporary indicator layer.

5. The method of claim 4, further comprising:
determining a pruning threshold for the first pruning;
identifying an element of the temporary indicator layer that is less than the pruning threshold; and
pruning a neuron of the embedding neural network corresponding to the element of the temporary indicator layer.

6. The method of claim 4, further comprising:
removing the temporary indicator layer from the embedding neural network following the second progressive pruning stage.

7. The method of claim 1, further comprising:
identifying a subset of layers of the embedding neural network for fine-tuning, wherein the first pruning is performed on the subset of layers of the embedding neural network.

8. The method of claim 7, wherein:
the subset of layers includes a feed-forward layer.

9. The method of claim 1, further comprising:
adding an adapter layer to the embedding neural network prior to the first progressive pruning stage.

10. The method of claim 1, further comprising:
pretraining the embedding neural network prior to the first progressive pruning stage.

11. The method of claim 10, wherein:
the first fine-tuning comprises a few-shot fine-tuning based on less than 1% of an amount of training data used for the pretraining.

12. A method comprising:
receiving a query of a first modality, wherein the query describes an element;
embedding the query into a multimodal embedding space using an embedding neural network to obtain a query embedding, wherein the embedding neural network is trained using a progressive pruning procedure; and
providing a search result of a second modality different from the first modality based on the query embedding in response to the query, wherein the search result includes the element described by the query.

13. The method of claim 12, further comprising:
comparing the query embedding to a candidate embedding corresponding to the search result, wherein the search result is retrieved based on the comparison.

14. The method of claim 12, wherein:
the first modality of the query is a text modality and wherein the second modality of the search result is an image modality.

15. The method of claim 12, wherein:
the progressive pruning procedure comprises a plurality of pruning phases alternating with a plurality of fine-tuning phases.

16. An apparatus comprising:
at least one processor;
the apparatus further comprising a memory including instructions executable by the at least one processor; and
an embedding neural network comprising parameters stored in the memory and trained to convert a query into a multimodal embedding space to obtain a query embedding, wherein the embedding neural network is trained using a progressive pruning procedure.

17. The apparatus of claim 16, further comprising:
a training component configured to perform the progressive pruning procedure by performing a first progressive pruning stage, wherein the first progressive pruning stage includes a first pruning of the embedding neural network and a first fine-tuning of the embedding neural network, and performing a second progressive pruning stage based on an output of the first progressive pruning stage, wherein the second progressive pruning stage includes a second pruning of the embedding neural network and a second fine-tuning of the embedding neural network.

18. The apparatus of claim 16, further comprising:
a user interface configured to receive the query and display a search result obtained in response to the query.

19. The apparatus of claim 16, wherein:
the embedding neural network comprises a transformer architecture.

20. The apparatus of claim 16, further comprising:
a search engine configured to compare the query embedding to a candidate embedding.
